(19) United States
(12) Patent Application Publication
(10) Pub. No.: US 2018/0005432 A1
(43) Pub. Date: Jan. 4, 2018

(54) Shading Using Multiple Texture Maps

(71) Applicant: AR You Ready LTD., Tel Aviv (IL)

(72) Inventor: Omer Breiner, Tel Aviv (IL)

(21) Appl. No.: 15/196,295

(22) Filed: Jun. 29, 2016

(51) Int. Cl. G06T 15/60; G06T 15/04

(52) U.S. Cl. CPC G06T 15/60; G06T 15/04

(57) ABSTRACT

A computer-implemented method, computerized apparatus and computer program product for shading in computer graphics. An indication of a lighting condition at a location in a surface of an object is obtained. A set of texture maps mapping locations on the surface to pixel values according to different lighting conditions is obtained. An output value for a pixel corresponding the location in an image of a scene comprising the object is determined based on the indicated lighting condition and mapped pixel value of the location in one or more texture maps.

### TECHNICAL FIELD

The present disclosure relates to computer graphics in general, and to shading computation, in particular.

### BACKGROUND

Computer graphics deal with digital synthesizing and manipulation of visual content, e.g. generating images from digital two- (2D) or three-dimensional (3D) models representing geometric, optical and optionally physical data. The process of image generation by means of computer graphics is referred to as “rendering”. Typically, a description of a virtual scene containing information such as geometry, viewpoint, lighting, texture, and the like, is processed by a rendering program and output to either a vector or raster type digital image. Raster images are composed of a finite set of digital values, commonly known as “picture elements”, or “pixels” in short, whereas vector images are represented mathematically using polygons.

The rendering methods mainly in use can be roughly categorized either as pixel-by-pixel (image order) or primitive-by-primitive (object order) based approaches. For example, in ray casting or ray tracing methods, the modeled geometry is parsed for each pixel from a point of view outward, wherein the path of originating rays is followed and based on the objects or surfaces intersecting with or hit by them, a determination of the pixel's value and/or attributes, e.g., color, lighting, depth, texture coordinates, or the like, is made. Conversely, in methods such as 3D polygon rendering, the area that is visible at the viewpoint is determined first and then rays are created from every part of every visible surface and tracked back to the viewpoint. Specifically, in techniques that are most common such as scanline rendering or rasterization, a looping through each of the polygons or geometric primitives is performed to determine which pixels are affected by it, and the values of those pixels are accordingly modified or set.

The sequence of steps used to generate a raster image from a three-dimensional scene, referred to as the “rendering pipeline”, includes: creation of the scene from 3D geometric primitives (e.g. triangles, quadrilaterals, or the like, such as used in polygonal meshes or wireframes, defined by vertices connected by line segments); modeling and transformation, where each primitive is transformed from local coordinate system to 3D world coordinate system; camera/viewpoint transformation, where the world coordinates are transformed into the 3D camera coordinate system, with the camera as the origin; lighting, where illumination at a surface point is determined according to lighting setup and reflectance; projection transformation, where the 3D world coordinates are transformed into the 2D view of the camera; clipping and culling, where primitives falling outside the viewing frustum or back facing the camera are discarded; rasterization, where the 2D image space representation of the scene is converted into raster format and resulting pixel values are determined; and, shading and/or texturing, where individual pixels are assigned color values either based on interpolation from vertices attributes determined during rasterization, using a shading algorithm, or by texture mapping. In modern graphics processing this stage is usually referred to as “fragment shading”, as it is applied to single pixels, rather than acting on the geometry, e.g. as in vertex shading, which may be performed prior to rasterization for manipulating properties of 3D vertices, such as position, color, and the like.

The term “shading” in general refers to the depiction of depth perception in 3D models or illustration by varying levels of darkness. One prominent example of shading technique in prevalent use is cross-hatching, where perpendicular lines of varying closeness are drawn in a grid pattern to shade an area. The closer the lines are together, the darker the area appears. Likewise, the farther apart the lines are, the lighter the area appears.

In the context of computer graphics, shading is the process of setting or altering the color of an object or surface in the 3D scene, based on its angle to and distance from light sources (and, in some cases, angle to the viewpoint as well), to create a photorealistic effect. Shading by cross-hatching is sometimes used in non-photorealistic rendering methods.

The term “texture mapping” relates to a process in which a 2D raster or bitmap image is projected onto a 3D object as if being wrapped around it, whereby the object acquires a surface appearance that resembles the image. This technique allows to add details, patterns, roughness or the like to a surface, for a richer look than could otherwise be achieved with limited number of geometric primitives. The projection between the 3D surface and 2D texture coordinates is sometimes known as “UV mapping”, where the letters U, V denote axes of the texture map to distinguish them from the axes of the 3D object denoted by X, Y, Z.

### BRIEF SUMMARY

One exemplary embodiment of the disclosed subject matter is a computer-implemented method comprising: obtaining an indication of a lighting condition at a location in a surface of an object; obtaining a set of texture maps each of which mapping between locations on the surface and pixel values, the set comprising at least two texture maps conforming to different lighting conditions; and determining, based on the lighting condition and a mapped pixel value of the location in one or more texture maps, an output value for a pixel corresponding the location in an image of a scene comprising the object.

Another exemplary embodiment of the disclosed subject matter is a computerized apparatus having a processor, the processor being adapted to perform the steps of: obtaining an indication of a lighting condition at a location in a surface of an object; obtaining a set of texture maps each of which mapping between locations on the surface and pixel values, the set comprising at least two texture maps conforming to different lighting conditions; and determining, based on the lighting condition and a mapped pixel value of the location in one or more texture maps, an output value for a pixel corresponding the location in an image of a scene comprising the object.

Yet another exemplary embodiment of the disclosed subject matter is a computer program product comprising a non-transitory computer readable storage medium retaining program instructions, which program instructions when read by a processor, cause the processor to perform a method comprising: obtaining an indication of a lighting condition at a location in a surface of an object; obtaining a set of texture maps each of which mapping between locations on the surface and pixel values, the set comprising at least two texture maps conforming to different lighting conditions; and determining, based on the lighting condition and a mapped pixel value of the location in one or more texture maps, an output value for a pixel corresponding the location in an image of a scene comprising the object.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show illustrative examples of shading in accordance with some exemplary embodiments of the disclosed subject matter;

FIG. 2 shows a flowchart diagram of a method, in accordance with some exemplary embodiments of the subject matter; and

FIG. 3 shows a block diagram of an apparatus, in accordance with some exemplary embodiments of the disclosed subject matter.

### DETAILED DESCRIPTION

Shading is concerned with how the color and brightness of a surface varies with lighting and constitutes an important feature of the rendering process of computer-generated imagery. Typically, shading models and programs attempt to approximate physical properties of particular materials and their interaction with light of particular source. Often these models may involve complex calculations, such as evaluating a Bidirectional Reflectance Distribution Function (BRDF), i.e. a function that defines how light is reflected at an opaque surface, in the form of a ratio between the radiance emitted in an outgoing direction and the irradiance incident from an incoming light direction, or performing Sub-Surface Scattering (SSS) computation, where a mechanism modeling light penetration and travel within the surface, from entering to re-emission at possibly a different point, is employed to account for reflectance off slightly translucent materials, like human skin, for example. Solving these models in real time thus requires increasingly advanced graphic library functions (such as available in Direct3D™ by Microsoft™, or OpenGL™ by Silicon Graphics™ and Khronos Group™), as well as powerful Graphics Processing Units (GPUs).

The creation of graphics content and development of shader programs, while being interrelated, are processes usually detached from one another and performed by people of different disciplines and skills, e.g. artists and designers may use application programs for 3D content rendering, incorporating shaders developed by coders or engineers. An artist may desire to construct a scene with objects of various materials, each of which may be associated with a particular shader, aimed to mimic the look of that material under a certain lighting condition. For example, different materials such as wood, brushed metal, marble, velvet, leather, and so forth, may be modeled by different shading functions, possibly not even all originating from the same developer. However, for achieving high quality results at reasonable efforts, the artist may need to understand the underlying real physics in play, as well as how it is translated into the User Interface (UI) of the particular shader used. Controlling the input and settings of each shader to produce an overall plausible outcome may prove as a non-trivial task, which, on many occasions, may further require extensive trial and error experimentations. Such process may be unduly prolonged due to the extended duration of rendering when intricate computations and multiple inputs are involved, e.g. multiple maps depicting the diffuse reflection at each of the different surface layers (such as an epidermal, subdermal, and likewise layers in the skin example), imposing long waiting periods until results can be reviewed by the content creator. In addition, the challenge may rise ten folds when using objects of different materials in a single scene, as the optimal result for each specific material may be obtained under different lighting conditions, thus in order to bring all shaders to perform optimally together the physical correctness of at least a portion of them may need to be disturbed.

In the context of computer graphics, the term “baking” in general refers to the recordation of some aspect of an object's material or geometry as an image. The recorded image can then be used to substitute computation of certain characteristics during rendering to save time. For example, a texture originally generated using a procedural scheme can be recorded as an image, i.e. a texture map. Baking can also refer to the consolidation of several channels or maps into a single image, thereby simplifying the number of texture images used. Baked textures can be used for embedding or transferring certain details from one model to another, such as, for example, small details maps, occlusion maps, normal maps, or the like.

One technical problem dealt with by the disclosed subject matter is to provide relatively fast deterministic shading of objects in a rendered 3D scene. For the clarity of the disclosure, the disclosed subject matter is exemplified with respect to proper 3D objects. However, the disclosed subject matter is not limited to such 3D objects and may be applied on 2D objects as well, e.g. planar surfaces embedded in a 3D scene.

In some exemplary embodiments, the shading in accordance with the disclosed subject matter can be performed by a computerized device having relatively reduced computational power, such as a device not having a GPU, a mobile device, augmented reality glasses, or the like.

One technical solution is to represent a material using a finite set of colors or textures depicting two or more surface areas of the material under different lighting conditions. For example, one of the set members may stand for a fully lit surface and another for a fully shadowed one. Shading of an object composed of this material is then performed by determining the lighting condition at each location or area of interest on the object's surface and assigning to it a color or texture accordingly, possibly mixing together values of different set members, e.g. the lit and shadowed portrayals of that spot. The lighting condition may be calculated using a predetermined function.

In some exemplary embodiments, the function used for calculating a lighting condition at a surface location may be relatively simple and light-weight in terms of processing and memory resources, such as, for example, the Lambertian reflectance model (i.e., ideal diffuse), calculated as the dot product of the surface's normal and the light source's direction, multiplied by the base color and the light's intensity. Additionally or alternatively, specular reflection model simulating gloss highlights on shiny objects may be applied, calculated in a similar manner using the dot product of the surface's normal and the half way vector between the directions of the viewpoint and light source, for example, as proposed in the Blinn-Phong model.

In some exemplary embodiments, the basic diffuse or specular lighting results may be used as a “mix map”, whereby defining for each pixel or surface location a mixture of the corresponding values in each map, based on the associated texture coordinates. For example, in total illumination conditions, pixel X may be set to 100% from the lit map and 0% from the dark map. In total darkness, pixel X may be set to 0% from the lit map and 100% from the dark map. In a lighting condition of 20% illumination, the value of the pixel may be computed as a function of the corresponding values in both maps, such as for example, a weighted average of 20% from the lit map and the remaining 80% from the dark map, i.e., 0.2*lit(X)+0.8*dark(X).

In the context of the present disclosure, the term “map” or “texture map” may be understood as referring also to a single color value, whereby a surface area of a smooth consistency and uniform color may be represented.

In some exemplary embodiments, shading by cross-hatching may be employed. A plurality of texture maps may be used to create a sense of dark and bright areas at varying degrees, such as by using a different number of cross-hatching levels in each map. For example, 4 different texture maps with 4 levels of cross-hatching may be used, where a map corresponding to the brightest spots is of level zero containing no hatching, a subsequent map corresponding to slightly darker shades is of level one and contains a pattern of slanted lines at one direction, a third map corresponding to mid-level shaded areas contains two levels of cross lines slanted at opposing directions, and a last map corresponding to the darkest level contains lines patterns at three directions, e.g. slanted at both opposing directions and crossing over horizontally. Additionally or alternatively, different crosshatching level maps may be used to create deterministic patterns over an object's surface, using a given UV mapping thereof, for example.

It will be appreciated that the term “cross-hatching” as used in the context of the present disclosure is not intended to be limiting, and other similar techniques, where patterns at varying densities and/or scales simulate different illumination intensities, may be applied, in addition or alternatively thereto, such as, for example, stippling, scumbling, hatching, contour-hatching, random lines, or the like.

In some exemplary embodiments, the range of possible values obtained by lighting calculation may be partitioned into one or more groups or sections. Each section may be associated with a different map, such that where a computed lighting value belongs to a section, an output pixel value is determined from the associated map, based on the corresponding UV coordinates. In some further exemplary embodiments, the sections may be consecutive real intervals and may be each associated with a pair of maps, one for the lower endpoint and another for the higher endpoint. An output value for a pixel may be determined by interpolating respective values from both maps, using the relative distance between a computed lighting value and the endpoints of the section containing it as the interpolation parameter. Any one of common interpolation methods may be used, e.g., nearest-neighbor interpolation, such that the output value may be determined from the map corresponding to the nearest endpoint; linear interpolation, where the output value may be determined as a weighted average of the values in the two maps, with weights corresponding to the relative distance from each endpoint; or the like.

One technical effect of utilizing the disclosed subject matter is to facilitate the mimicking of sophisticated physical properties of real-world materials, without resorting to complex, resource-intensive computations. The simplification and shortening of the overall rendering procedure thus resulting allows, for example, to compute and display 3D content on devices with limited processing capabilities (e.g., mobile devices), in real time and at a higher quality level than otherwise available. Additionally or alternatively, the conserving of resources enabled by the disclosed subject matter may be exploited for achieving faster and optionally more elaborate results when using devices supporting high graphics processing capabilities. In any event, it will be appreciated that the disclosed subject matter may be highly scalable, and can be implemented in any environment that supports shader programming, without requiring a dedicated 3D engine or other special purpose software and/or hardware.

Another technical effect of utilizing the disclosed subject matter is to provide creators of 3D content, as well as graphics software developers, with a workflow for rendering and/or programming shading effects that is relatively fast and intuitive, thereby allowing them to achieve a desired result in an easy, rapid and cost-effective manner. Various materials can be represented, and their look under a certain lighting condition mimicked, at a considerably minimal amount of guesswork on a user's part, and without the user being required to know the underlying physical properties of those materials that make them react to light in a certain way. In some exemplary embodiments, the user may use a reference image from which one or more colors or textures can be selected, choose maps arbitrarily from other available sources, or the like. It will be appreciated that multiple different materials may be used in a 3D scene without any of them being fixed to a specific look once a lighting setup is determined. Rather, the look of an object can be dynamically and independently changed, simply by the reselection of associated texture maps, even after lighting has already been calculated.

One illustrative example of a use case in which the disclosed subject matter may be employed is offline rendering, where the fast, deterministic and intuitive workflow provided by the disclosed subject matter may be used by an artist to achieve a desired appearance of the rendered 3D content at a reduced rendering time, also leading thereby to lower production costs.

Another illustrative use case example is real-time interactive rendering, where the computational load involved in processing and displaying 3D content may be lowered using the disclosed subject matter, either overall or strategically for specific content components, thus enabling rendering of 3D content with sophisticated shading effects in real-time even by low-end processors, or rendering content of higher detail or larger number of objects at a time by high-end processors.

Yet another illustrative use case example is real-time rendering on mobile devices, applicable in the context of augmented or virtual reality content, for example, where complex computations may be required to be performed simultaneously, optionally requiring a single, un-tethered mobile device to handle a great share of the computations in real time.

It will be appreciated that the disclosed subject matter may be used in conjunction with any known and commonly available computer graphics shading functions and models, such as, for example, cube mapping for reflection and/or refraction modelling, Fresnel factor for simulating specular highlights at silhouettes, anisotropic reflection, waxiness effect of translucent bodies, or the like.

It will be appreciated that the disclosed subject matter may be thought of as an extension of shading techniques using one or more baked textures of specific effects, as dynamic reaction to changing lighting conditions may be enabled, thus providing more versatility.

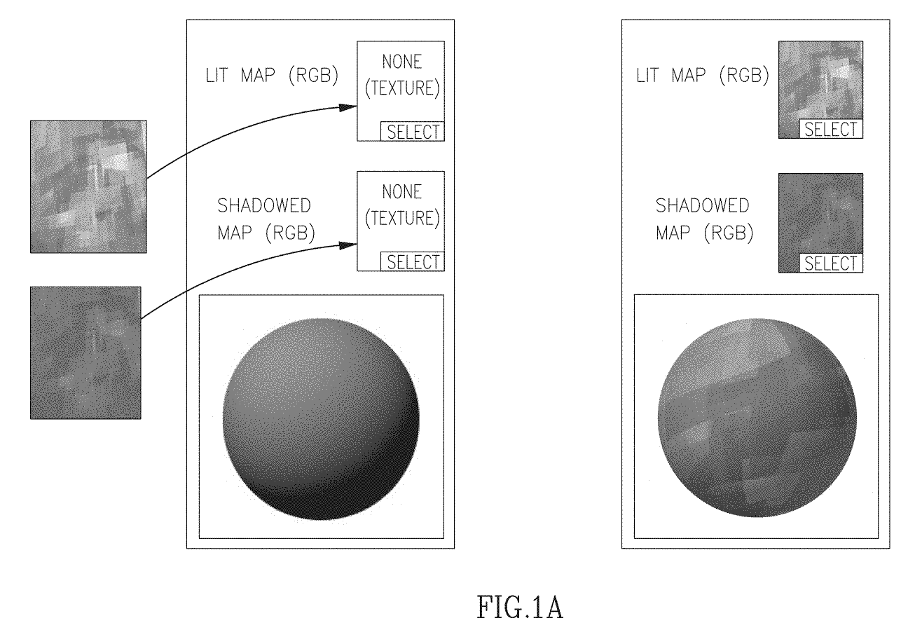

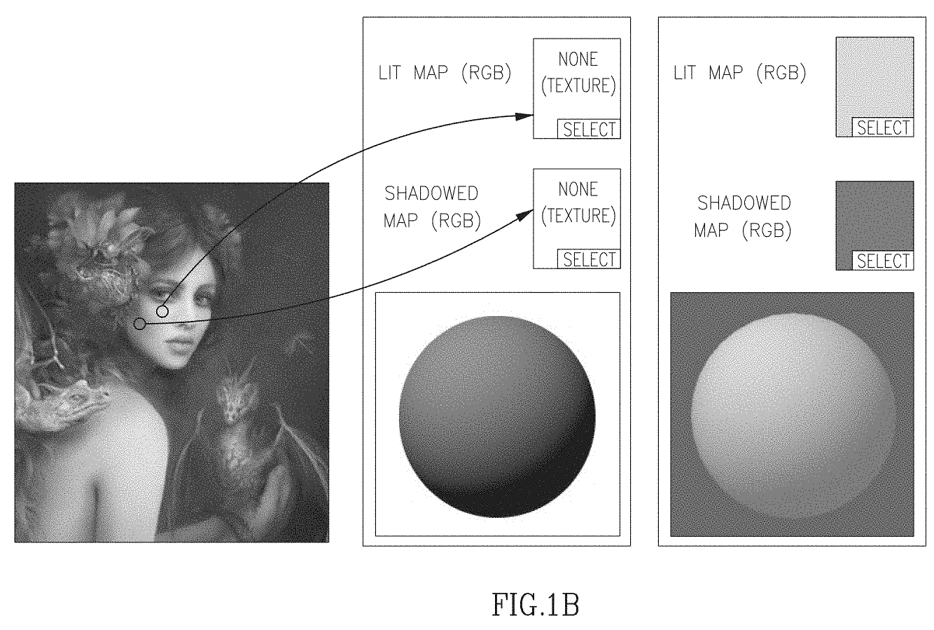

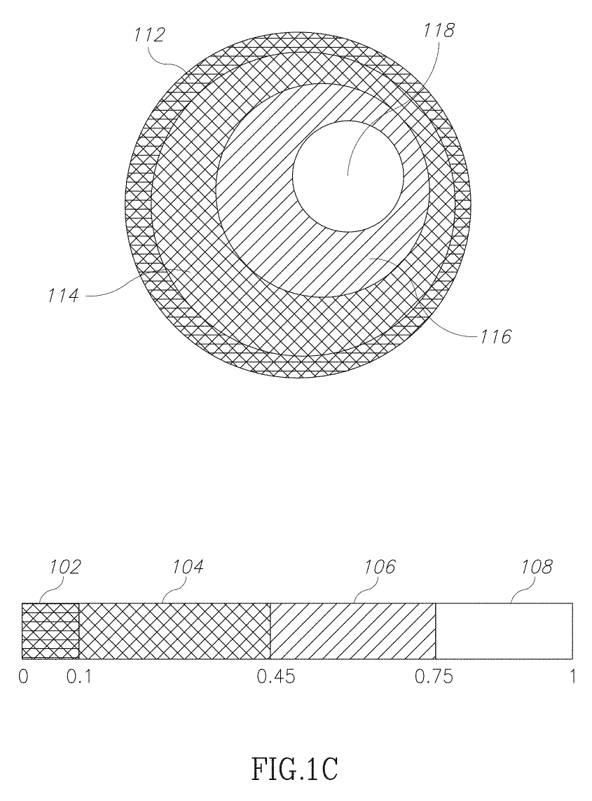

Referring now to FIGS. 1A-1C showing illustrative examples of shading in accordance with some exemplary embodiments of the disclosed subject matter.

FIG. 1A shows an illustrative example of shading an object using multiple maps depicting the object's appearance under different illumination levels. As further exemplified in FIG. 1A, two corresponding texture maps may be used, one representing a lit area and another representing a shadowed area. The object, a sphere in this case, is shown on the left side after lighting, where the illumination level at each of the visible surface locations has been determined. On the right side is shown the result of applying a mixture of the lit and shadowed maps, weighted according to the lighting, such that the object appears as both shaded and textured. The smooth transitioning between the lit and shadowed portions, such as illustrated in FIG. 1A, may be achieved by use of a linear interpolation scheme, for example.

FIG. 1B shows another illustrative example of shading an object using multiple maps of different illumination conditions. Two maps, one for lit areas and another for shadowed ones, may be used, similarly as in FIG. 1A. As exemplified in FIG. 1B, a reference image may be used from which one or both maps are derived, e.g. by selecting a region of interest therein. The selection may be restricted to a single color value, resulting in a constant mapping for all UV coordinates. The object is shown on the left and right side prior to and after applying the weighted combination of lit and shadowed values, similarly as in FIG. 1A. The resulting shaded sphere in FIG. 1B is shown against a dark background for better clarity and understanding of the disclosed subject matter.

FIG. 1C shows an illustrative example of cross-hatching shading. The range of possible values representing lighting conditions is assumed to be the real interval [0,1], such as when calculated using the Lambertian reflectance function. The range may be divided into multiple sections, each associated with a corresponding texture map having different number of cross-hatching levels. For example, four texture maps having either zero, one, two, or three levels of hatching and cross-hatching, such as Maps 102 to 108, may be used. The range [0,1] of possible lighting values may be divided into consecutive sections which may be associated each with one of those maps, e.g. [0,0.1], [0.1,0.45], [0.45,0.75] and [0.75,1], associated with Map 102, Map 104, Map 106 and Map 108, respectively, as shown in FIG. 1C at the bottom. Such partitioning and association of lighting values and ranges with limited number of colors or textures applied in shading may be referred to as “sharp lighting map”. On the top of FIG. 1C are shown exemplary shading results of a sphere, wherein a cross-hatching pattern is applied to an area based on its lighting conditions, i.e. in accordance with the map associated with a section containing the lighting values obtained in that area. In the illustrative example shown in FIG. 1C, Map 102 is thus applied to Area 112, Map 104 to Area 114, Map 106 to Area 116, and Map 108 to Area 118.

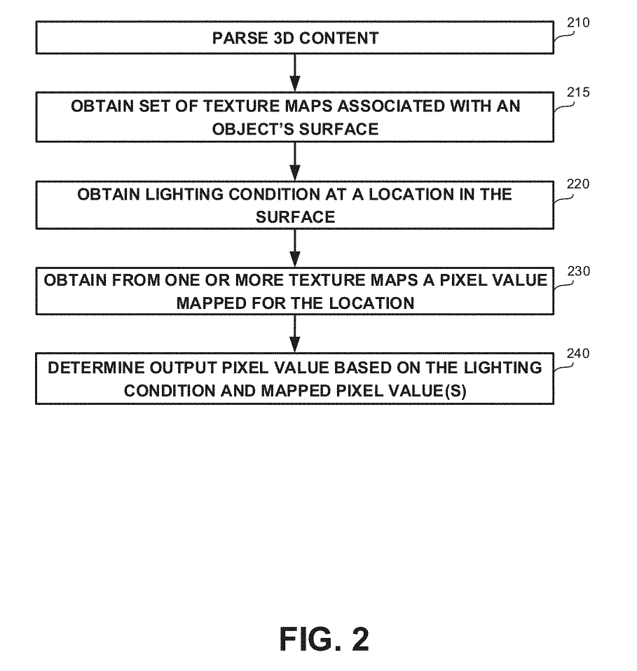

Referring now to FIG. 2 showing a flowchart diagram of a method, in accordance with some exemplary embodiments of the subject matter.

On Step 210, the 3D content to be rendered may be parsed from a description of a virtual scene, provided in some predetermined format. The description may be contained in a file, or received interactively from a user via engagement with a UI of a 3D modelling application program. The parsed 3D content may comprise a lighting setup, such as a light source's location, type (e.g., point or directional), color, or the like, for each of the one or more lighting sources used; geometric data of each object in the scene, e.g. vertices' coordinates in the 3D virtual space; viewpoint location; and the like.

On Step 215, a set of texture maps associated with an object's surface may be obtained. The set may comprise two or more maps depicting the surface's appearance under different lighting conditions. In some exemplary embodiments, a first map may conform to an area when lit, and a second map may conform to the same area when shadowed. Each of the texture maps may define a mapping from a surface location to a corresponding pixel value. A projection between the surface and each of the texture maps may be defined, whereby the texture map is wrapped on the surface, thus inducing the mapping. The projection may be explicitly defined by a user, e.g. by associating vertices with UV coordinates, or may be a default or canonical projection implicit, for example, from an object's shape, e.g. the geographic or equidistant cylindrical projection of a sphere. In some exemplary embodiments, one or more texture maps in the set may be defined to consist of a single value, thus inducing a constant mapping. A map of this kind may be defined, for example, by a user specifying a color value, instead of providing a raster image.

On Step 220, a lighting condition at a location in the surface may be obtained. The lighting condition may be calculated using a predetermined function. In some exemplary embodiments, the function may model a simple diffuse reflection, such as the Lambertian reflectance function. Additionally or alternatively, the function may model specular reflection or highlights, such as in the Blinn-Phong reflectance model. The lighting condition may be calculated either on a pixel-by-pixel or primitive-by-primitive basis, depending on the overall rendering method used. For example, in case of rasterization rendering, the lighting may be calculated at each of the vertices' positions, and then interpolated from those values for any interior location in the enclosed facet, e.g. using barycentric coordinates.

On Step 230, a pixel value mapped for the location is obtained from one or more of the texture maps obtained on Step 215. The mapped pixel value may be obtained based on the texture coordinates corresponding to the location. For example, in case the location is projected under a respective UV mapping to image coordinates (i,j), then the pixel value at that image location, i.e. i-th row and j-th column, may be retrieved. If the projected coordinates of a location are at sub-pixel level, i.e. non-integer, the pixel value may be obtained by interpolation of the mapped values at the closest integer coordinates. In some exemplary embodiments, the texture map from which a mapped pixel value is obtained may be determined based on the lighting condition obtained on Step 120, such as by using a sharp lighting map. In some exemplary embodiments, the range of possible values by which lighting conditions can be represented may contain one or more intervals. Each of the two endpoints of an interval may be associated with a different texture map. A pair of texture maps, from each of which respective mapped pixel values for the location are obtained, may be thus determined as the maps associated with the endpoints of the interval where the lighting value representing the lighting condition at the location lies.

On Step 240, an output value for a pixel corresponding the location may be determined, based on the lighting condition obtained on Step 220 and the one or more pixel values obtained on Step 230. In some exemplary embodiments, the output value may be a mixture of those values. The weight of each value in the mixture may be determined as a function of the relative distance between the lighting value representing the lighting condition and each of the endpoints of the interval containing it. The function may be an interpolation operation, such as, for example, nearest-neighbor interpolation, linear interpolation, or the like. In some exemplary embodiments, Steps 230 to 240 may be performed simultaneously, such as, for example, where a sharp lighting map is employed, in which case the lighting condition determines a single color or texture from which the output value is obtained, based on the UV coordinates of the surface location.

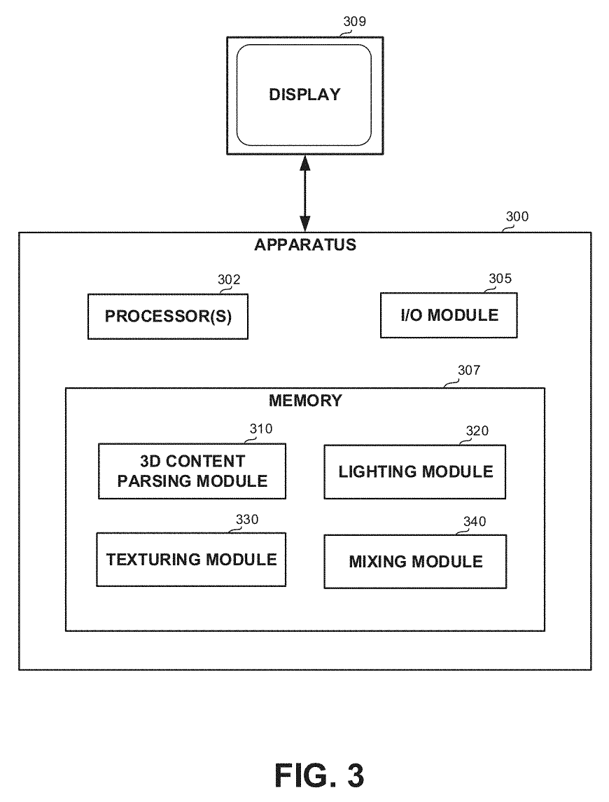

Referring now to FIG. 3 showing an apparatus in accordance with some exemplary embodiments of the disclosed subject matter. An Apparatus 300 may be configured to perform rapid shading with multiple texture maps, in accordance with the disclosed subject matter.

In some exemplary embodiments, Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) Module 305. I/O Module 305 may be utilized to provide an output to and receive input from a user, such as select texture maps, define UV mappings, associate lighting values to texture maps, define mixing schemes, or the like.

In some exemplary embodiments, Apparatus 300 may comprise a Memory 307. Memory 307 may be a hard disk drive, a Flash disk, a Random Access Memory (RAM), a memory chip, or the like. In some exemplary embodiments, Memory 307 may retain program code operative to cause Processor 302 to perform acts associated with any of the subcomponents of Apparatus 300.

In some exemplary embodiments, Apparatus 300 may be coupled with a Display 309. Display 309 may be a Cathode Ray Tube (CRT) display, a Liquid Crystal Display (LCD), a Laser video display, optical head-mounted display, Head-Up Display (HUD), or the like. Display 309 may be configured to display visual content generated or processed by Apparatus 300.

3D Content Parsing Module 310 may be configured to obtain and parse a description of a virtual scene to be rendered, similarly as in Step 210 of FIG. 2. 3D Content Parsing Module 310 may be configured to determine, based on the parsed description, various parameters of the visual content, such as geometric data of objects comprised in the scene, lighting setup, viewpoint location, and the like.

Lighting Module 320 may be configured to calculate a lighting condition at a location in a surface of an object in the virtual scene per a given lighting setup, similarly as in Step 220 of FIG. 2. Lighting Module 320 may obtain the lighting setup and the geometric data of the object, e.g. a triangular mesh representation or the like, as well as other scene parameters, such as the viewpoint location, from 3D Content Parsing Module 310.

Texturing Module 330 may be configured to obtain a set of texture maps associated with a surface of an object in the scene and depicting its appearance under different illumination conditions, similarly as in Step 215 of FIG. 2. Texturing Module 330 may be configured to retrieve from any of the texture maps a pixel value mapped for a given surface location, using either a custom or default UV mapping, similarly as in Step 230 of FIG. 2.

Mixing Module 340 may be configured to determine an output value for a pixel corresponding the given surface location, based on the lighting condition therein, as calculated by Lighting Module 320, and the corresponding pixel values obtained therefor by Texturing Module 330, similarly as in Step 240 of FIG. 2. Mixing Module 340 may be configured to apply a mixing scheme whereby the output pixel value is determined as a mixture of the pixel values from the texture maps, dependent on the lighting condition as a parameter. Mixing Module 340 may be configured to interpolate pixel values using either nearest-neighbor interpolation, linear interpolation, or the like.

In some exemplary embodiments, Mixing Module 340 may be further configured to determine, based on the lighting condition, from which of the texture maps a mapped pixel value is to be retrieved by Texturing Module 330, such as, for example, where disjoint groups of lighting conditions are assigned with different maps or map pairs.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining an indication of a lighting condition at a location in a surface of an object;
obtaining a set of texture maps each of which mapping between locations on the surface and pixel values, the set comprising at least two texture maps conforming to different lighting conditions; and
determining, based on the lighting condition and a mapped pixel value of the location in one or more texture maps, an output value for a pixel corresponding the location in an image of a scene comprising the object.

2. The computer-implemented method of claim 1, wherein the lighting condition is indicated by a lighting value within an interval of real numbers, the interval comprising one or more sections the endpoints thereof are associated each with a different texture map from the set, wherein the output value is determined using one or both of the texture maps associated with the endpoints of the section containing the lighting value.

3. The computer-implemented method of claim 2, wherein the output value is determined as a function of the relative distance between the lighting value and the endpoints of the containing section.

4. The computer-implemented method of claim 3, wherein the function interpolates the texture maps using an interpolation method selected from the group consisting of: linear interpolation; and nearest neighbor interpolation.

5. The computer-implemented method of claim 1, wherein the lighting condition is computed based on given lighting settings for the scene using a diffuse reflection modelling function.

6. The computer-implemented method of claim 1, wherein the different lighting conditions are varying degrees of illumination of the object.

7. The computer-implemented method of claim 1, wherein the texture maps are of different number of cross-hatching levels.

8. The computer-implemented method of claim 1, further comprising displaying in a display a graphical representation of the object, wherein the graphical representation of the object comprises the pixel having the output value.

9. The computer-implemented method of claim 8, wherein said determining is performed by a computerized device, the computerized device comprising the display, whereby on-the-fly rendering of the object is performed by the computerized device.

10. The computer-implemented method of claim 1, wherein the mapped pixel value of the location in each texture map is obtained by wrapping the texture map on a 3D representation of the object.

11. The computer-implemented method of claim 1, wherein the lighting condition indication is obtained for a plurality of locations in the surface and the output value is determined for corresponding pixels in the image.

12. The computer-implemented method of claim 1, wherein said determining is performed for a plurality of pixels, wherein the lighting condition indication is obtained for corresponding locations in the surface.

13. The computer-implemented method of claim 1, wherein one or more texture maps are consisted of a single value, whereby representing a spatially constant mapping.

14. A computerized apparatus having a processor, the processor being adapted to perform the steps of:
obtaining an indication of a lighting condition at a location in a surface of an object;
obtaining a set of texture maps each of which mapping between locations on the surface and pixel values, the set comprising at least two texture maps conforming to different lighting conditions; and
determining, based on the lighting condition and a mapped pixel value of the location in one or more texture maps, an output value for a pixel corresponding the location in an image of a scene comprising the object.

15. The computerized apparatus of claim 14, wherein the lighting condition is indicated by a lighting value within an interval of real numbers, the interval comprising one or more sections the endpoints thereof are associated each with a different texture map from the set, wherein the output value is determined using one or both of the texture maps associated with the endpoints of the section containing the lighting value.

16. The computerized apparatus of claim 15, wherein the output value is determined as a function of the relative distance between the lighting value and the endpoints of the containing section.

17. The computerized apparatus of claim 14, wherein the different lighting conditions are varying degrees of illumination of the object.

18. The computerized apparatus of claim 14, wherein the texture maps are of different number of cross-hatching levels.

19. The computerized apparatus of claim 14, wherein one or more texture maps are consisted of a single value, whereby representing a spatially constant mapping.

20. A computer program product comprising a non-transitory computer readable storage medium retaining program instructions, which program instructions when read by a processor, cause the processor to perform a method comprising:
obtaining an indication of a lighting condition at a location in a surface of an object;
obtaining a set of texture maps each of which mapping between locations on the surface and pixel values, the set comprising at least two texture maps conforming to different lighting conditions; and
determining, based on the lighting condition and a mapped pixel value of the location in one or more texture maps, an output value for a pixel corresponding the location in an image of a scene comprising the object.
